(19) United States
(12) Patent Application Publication
(10) Pub. No.: US 2014/0167424 A1
(43) Pub. Date: Jun. 19, 2014

(54) Magnetically Operated Latch

(71) Applicant: THE YOUNG ENGINEERS, INC., Lake Forest, CA (US)

(72) Inventor: Samuel Dale Frias, Lake Elsinore, CA (US)

(73) Assignee: THE YOUNG ENGINEERS, INC., Lake Forest, CA (US)

(21) Appl. No.: 13/719,957

(22) Filed: Dec. 19, 2012

(51) Int. Cl. E05C 19/16

(52) U.S. Cl. CPC E05C 19/163
USPC 292/140; 292/138; 292/145

(57) ABSTRACT

An actuator housing assembly comprising an actuator housing having an opening therein, a movable actuator member received in the opening, the actuator member having a front surface and a rear surface and being digitally movable in said opening, and a cam extending from the rear surface of said movable actuator member to operate a bolt which is biased by magnets of opposing polarity. The actuator housing assembly has means adapted to enable the attachment to and detachment from a bolt mechanism assembly having complementary means adapted to enable attachment and detachment.

### BACKGROUND OF THE INVENTION

Loret de Mola, US2012/0013134 A1.

Clifton Jr. U.S. Pat. No. 2,893,773 A.

Larsen, et al U.S. Pat. No. 5,927,773 A.

Andrews U.S. Pat. No. 3,743,336; Russell.

Loret de Mola, US2010/0244465 A1.

Gleason, et al U.S. Pat. No. 6,231,091 B1.

These patents relate to various fastening or latching arrangements. However, none involve the novel mechanism of this invention

### SUMMARY OF THE INVENTION

An easily modified closure latching system comprising the combination of a bolt mechanism assembly and an actuator housing assembly,

said bolt mechanism assembly comprising

a backing plate adapted to be mounted on a complementary surface of a panel

a bolt mechanism assembly housing attached to said backing plate,

a sliding bolt assembly carried by said bolt mechanism assembly housing, said sliding bolt assembly including a bolt adapted to engage and latch to a striker to close,

magnetic biasing means in said housing for biasing said end of the bolt out of the housing to latch to the striker

said bolt mechanism housing assembly including passage access for an internal cam adapted to overcome said magnetic biasing means and withdraw said end of the bolt to unlatch said external cam from said striker; and

complementary means attachably and detachably joining said bolt mechanism assembly to said actuator housing assembly,

said actuator housing assembly comprising

an actuator housing having an opening therein,

a movable actuator member received in said opening, said actuator member having a front surface and a rear surface and being movable in said opening,

said rear surface of said movable actuator member carrying a magnet adapted to rotate said internal cam when the actuator member is moved inwardly in said opening and to cause the internal cam to return to its original position in said opening when the actuator member is allowed to return to its original position, inward movement of said actuator member causing said bolt to withdraw sufficiently into said housing to unlatch said bolt from said striker.

In another embodiment, the invention comprises an easily modified closure latching system for a movable panel having an edge adjacent a fixed striker comprising a bolt and actuator assembly, comprising:

a sliding bolt carried by a bolt housing, said bolt adapted to engage and latch to a striker to close;

magnetic biasing means in said housing for biasing said end of the bolt out of the housing to latch to the striker;

said bolt housing including passage access for a hammer adapted to overcome said magnetic biasing means and withdraw said end of the bolt to unlatch from said striker;

an actuator housing having an opening therein;

a movable actuator member received in said opening, said actuator member having a front surface and a rear surface and being movable in said opening;

said movable actuator member operating a hammer, said hammer being adapted to be moved inwardly in said opening by said actuator and means associated with said actuator to cause the hammer to return to its original position when the actuator member is allowed to return to its original position, inward movement of said actuator member causing said bolt to withdraw sufficiently into said bolt housing to unlatch said bolt from said striker.

### THE DRAWINGS

In the drawings:

FIG. 1 is an exploded perspective view of the mechanism of this invention as it is disposed relative to a moveable panel such as a door and a frame to which the panel latches.

FIG. 2 is a perspective view showing the mechanism of this invention as it appears when installed in the panel.

FIG. 3 is an exploded perspective view showing the mechanism of the invention.

FIG. 4 is a perspective view taken through the line 4-4 in FIG. 2.

FIG. 5 is a more detailed exploded view of the mechanism of the invention.

FIG. 6 is a side sectional view of the mechanism of the invention.

FIG. 7 is another sectional view showing the mechanism of FIG. 6 installed in a panel and locked to the frame.

FIG. 8 shows the arrangement of FIG. 7 with the bolt withdrawn from the striker in the frame to reveal the unlocked position.

FIG. 9 is an exploded perspective frontal view of an alternate embodiment of the invention as it is disposed relative to a moveable panel such as a door and a frame to which the panel latches.

FIG. 10 is a perspective view of the embodiment of FIG. 9 showing the mechanism as it appears when installed in the panel.

FIG. 11 is an exploded perspective rear view showing the mechanism of FIG. 9.

FIG. 12 is a perspective view taken through the line 12-12 in FIG. 10.

FIG. 13 is a more detailed exploded view of the mechanism of FIG. 9.

FIG. 14 is a side sectional view of the mechanism of FIG. 9.

FIG. 15 is another sectional view showing the mechanism of FIG. 14 installed in a panel and locked to the frame.

FIG. 16 shows the arrangement of FIG. 15 with the bolt withdrawn from the striker in the frame to reveal the unlocked position.

### DESCRIPTION OF THE PREFERRED EMBODIMENTS

Parts List of First Embodiment

| | |
|---|---|
| bolt mechanism assembly | 10 |
| actuator housing assembly | 12 |
| panel | 14 |
| bolt mechanism backing plate | 16 |
| bolt housing | 18 |
| bolt | 20 |
| bolt end | 22 |
| striker | 24 |
| hole in push button actuator | 25 |
| push button actuator | 26 |
| four magnets on push button actuator | 27 |
| push button actuator housing | 28 |
| four magnets in actuator housing | 29 |
| internal cam | 30 |
| internal cam access opening in bolt housing | 32 |
| frame | 34 |
| split pin | 36 |
| split pin | 38 |
| holes in actuator housing to carry split pins 36 and 38 | 39 |
| spacer | 40 |
| split pin | 41 |
| spacer | 42 |
| holes in actuator housing to carry split pin 41 | 43 |
| magnet | 44 |
| external cam | 46 |
| split pin | 48 |
| slot in external cam | 50 |
| split pin | 52 |
| bolt magnet | 54 |
| bolt housing magnet | 56 |
| screws | 58 |
| helical coils | 60 |
| threads | 62 |

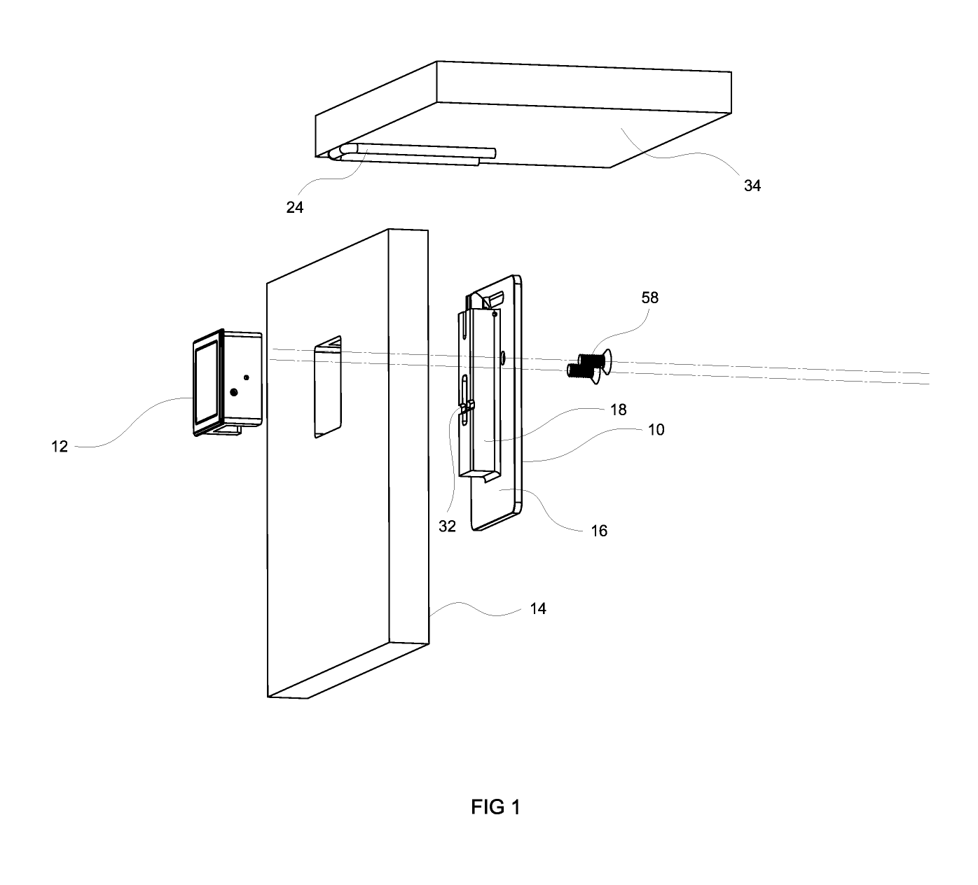

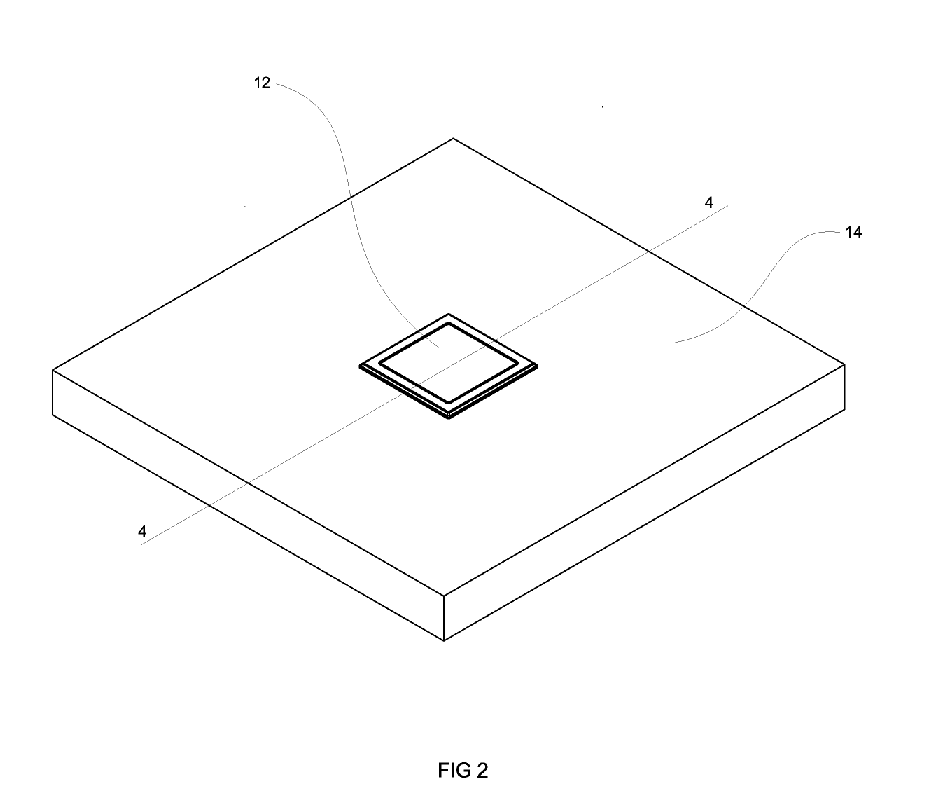

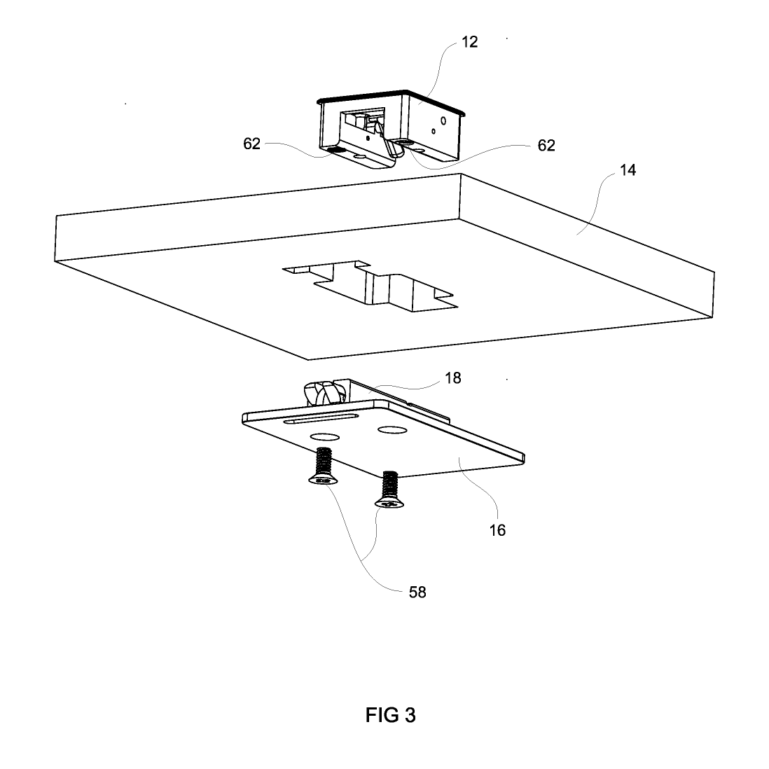

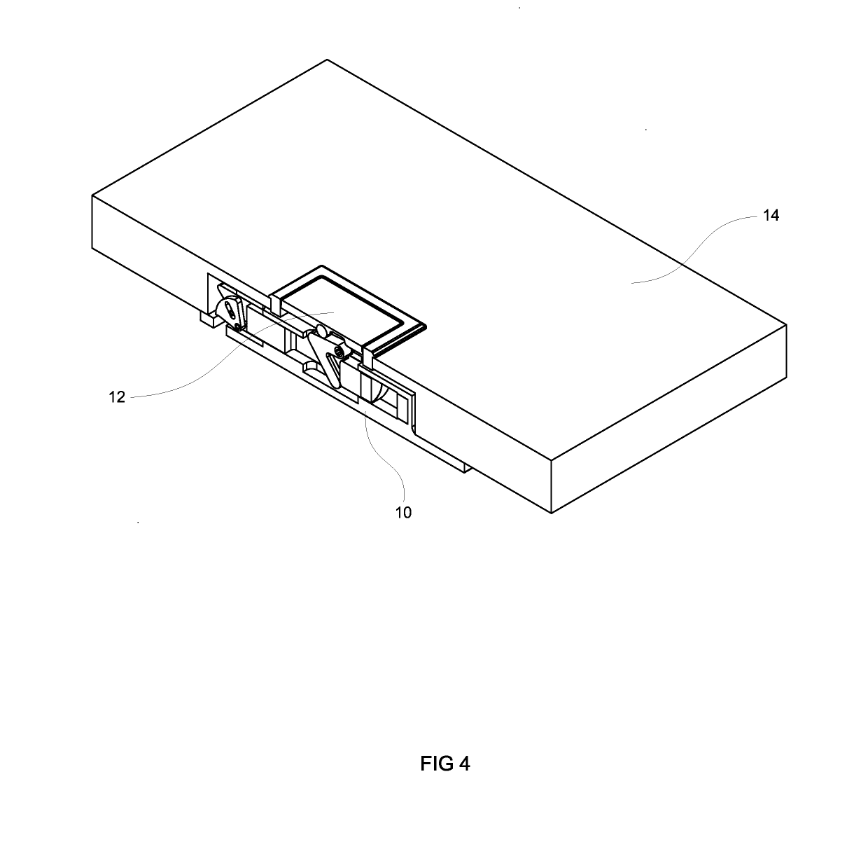

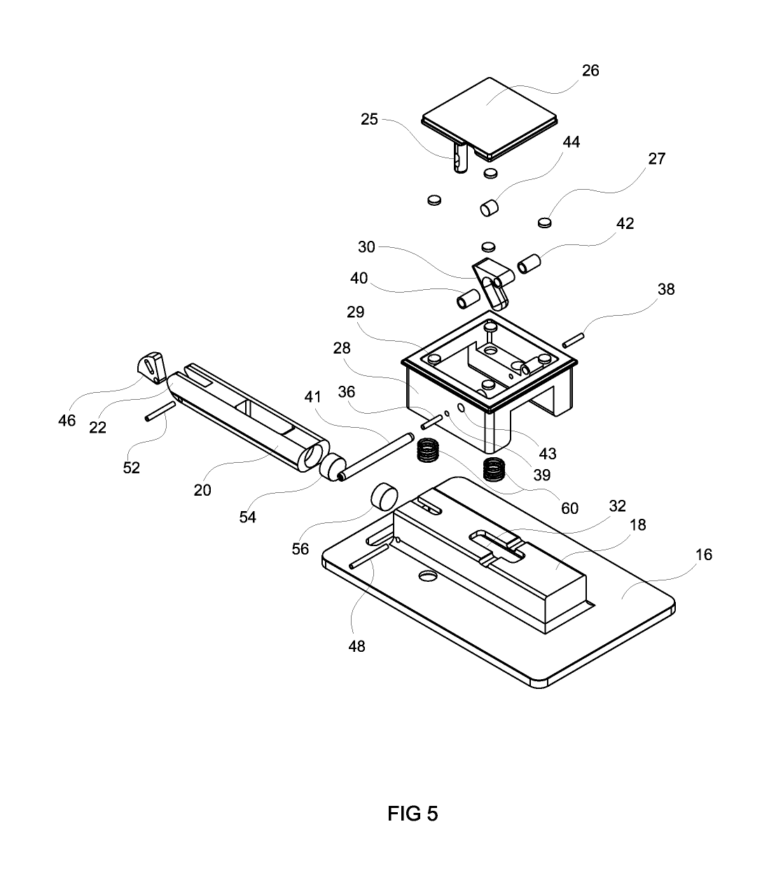

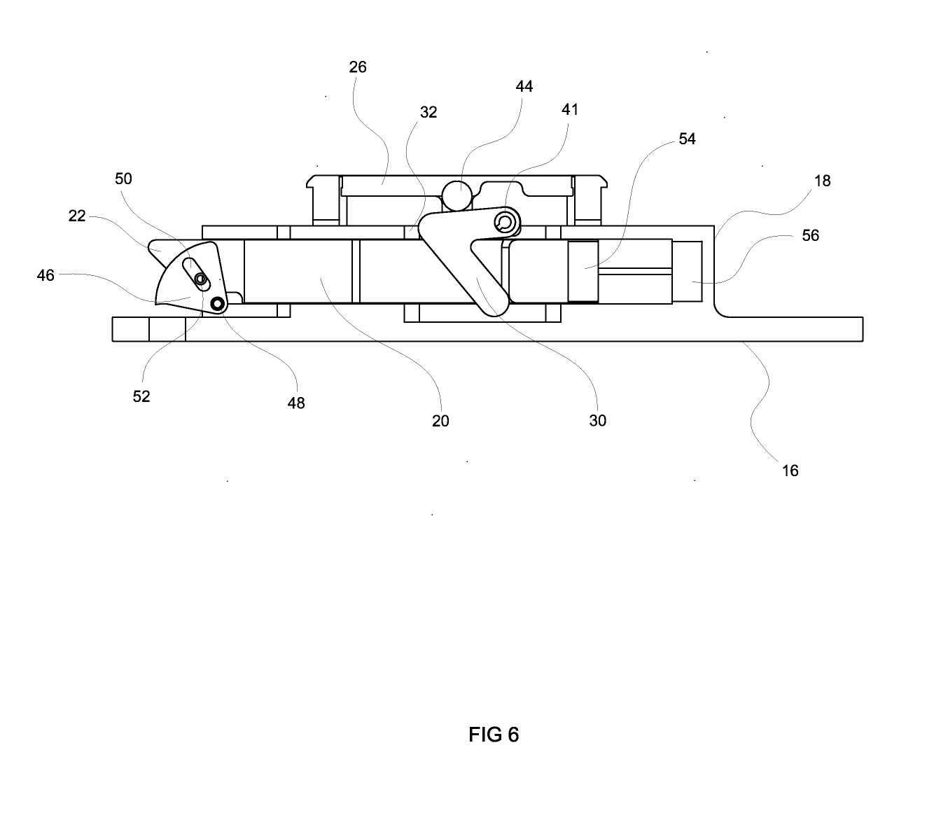

Turning to the drawings, FIGS. 1 to 8, in more detail, the bolt mechanism assembly 10 and actuator housing assembly 12 are mounted on panel 14. The bolt mechanism 10 has a backing plate 16. The bolt mechanism 10 also includes the bolt housing 18 in which is received bolt 20 with bolt end 22. The bolt 20 reciprocates within the bolt housing 18. The bolt end 22 is adapted to engage and latch to striker 24 which is carried on any standard storage locker frame 34, drawer frame and the like.

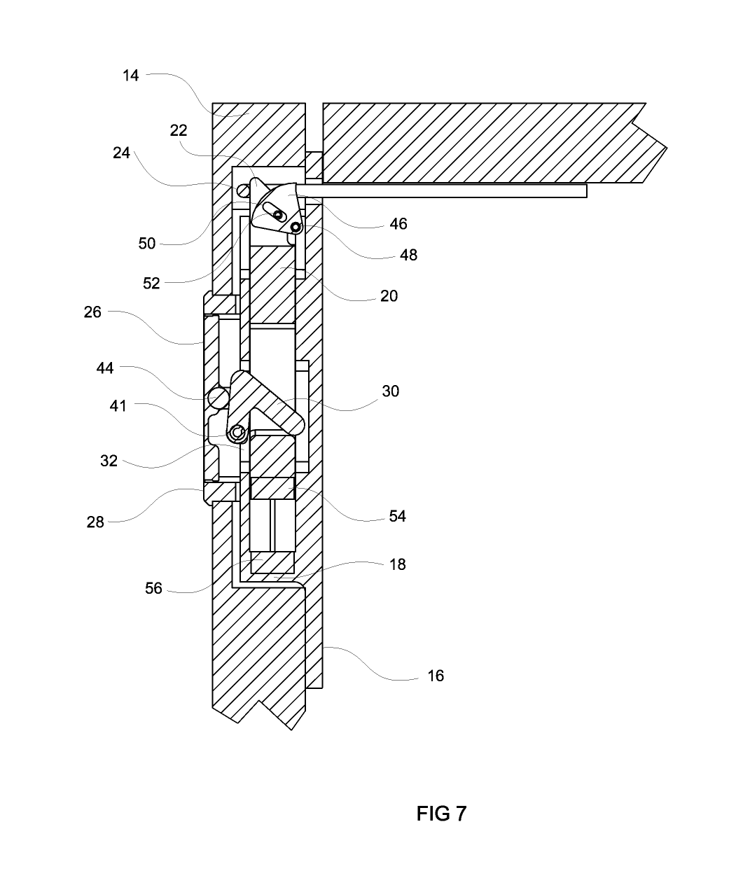

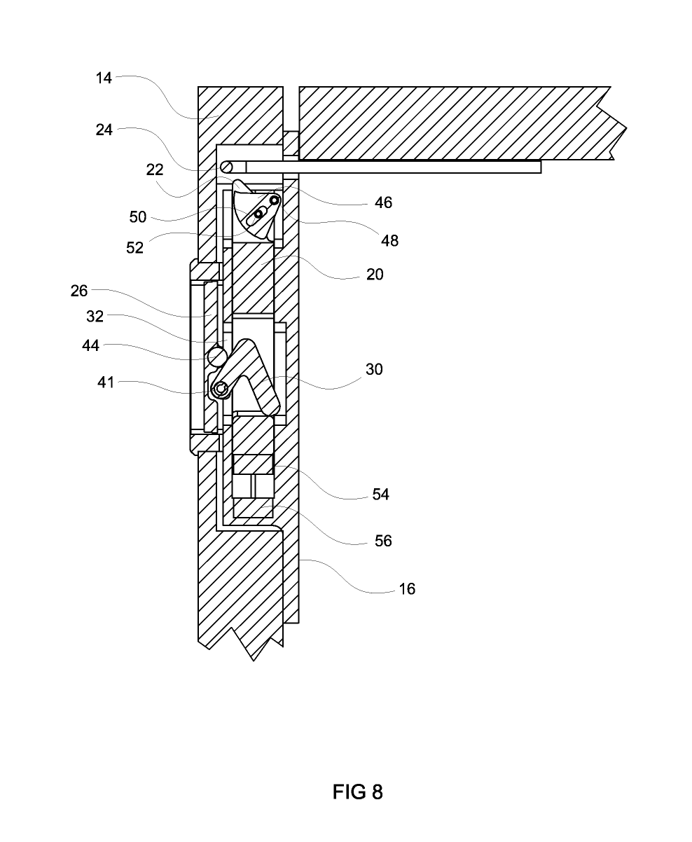

The actuator 26 is mounted in an actuator housing 28. The actuator housing carries the internal cam 30 on split pins 36 and 38, with centering of internal cam 30 within the actuator housing 28 being maintained by spacers 40 and 42. The cam 30 rotates on the pins as shown in FIGS. 7 and 8.

The actuator 26 can be a paddle, push button or rocker. These configurations are disclosed in the disclosure of Loret de Mola, US2012/0013134 A1 which is incorporated herein by reference.

The shape of the actuator can be square, round, oval, rectangular or any desired shape. The actuator housing is configured to accommodate the actuator shape selected.

The external cam 46 is rotatably carried by split pin 48 attached to the bolt housing 18. The external cam 46 has a slot 50. The pin 52 passes through slot 50 and is attached to the end 22 of bolt 20.

The bolt 20 carries within it a pair of opposite polarity magnets 54 and 56 which bias the end 22 of the bolt 20 into the latching position as shown in FIG. 7. When actuator 26 is pushed into its housing, the internal cam 30 rotates in opening 32 in bolt housing 18 by contact with magnet 44. The inward movement of actuator 26 causes the cam 30 to exert force on magnet 54 overcoming the repulsive magnetic force created by the opposite polarity of magnets 54 and 56. The bolt 20 is unlatched from striker 24, as shown in FIG. 8. When actuator 26 is released, the opposed polarity of the four magnets 29 in actuator housing 28 and the four magnets 27 on push button actuator 26 causes the push button actuator to return to its original position. The magnet 44 draws the cam 30 back to the position shown in FIG. 7, and the magnet 54 to return to the original position due to magnetic repulsion.

The bolt mechanism assembly 10 and the actuator housing assembly 12 are held together by screws 58 which are received in helical coils 60 carried in threads 62.

Split pins 36 and 38 are received in holes 39 in actuator housing 28 and pivotally engage the two holes 25 in actuator 26 to keep the actuator securely attached to the actuator housing.

Split pin 41 passes through spacers 40 and 42, cam 30 and holes 43 in actuator housing 26 to support cam 30. The spacers 40 and 42 are carried by split pin 41 on each side of cam 30 to keep the cam 30 centered.

Parts List Alternate Embodiment

| | |
|---|---|
| bolt mechanism assembly | 110 |
| actuator housing assembly | 112 |
| panel | 114 |
| bolt mechanism backing plate | 116 |
| bolt | 120 |
| striker | 124 |
| paddle actuator | 126 |
| actuator housing | 128 |
| bolt housing | 130 |
| holes in underside of actuator housing 128 | 132 |
| holes in panel 114 | 134 |
| holes in backing plate 116 | 136 |
| screws inserted through backing plate 116 | 138 |
| helicoils in holes 132 | 140 |
| hole in bolt | 142 |
| holes | 144 |
| holes | 146 |
| opening in panel 114 for receiving actuator | 148 |
| housing 128 and bolt housing 130 | |
| hammer | 150 |
| opening in bolt 120 for receiving hammer 150 | 152 |
| magnet | 154 |
| magnet | 156 |
| cam | 158 |
| end of bolt | 160 |
| fork | 162 |
| torsion spring | 164 |
| finger access opening in actuator housing 128 | 166 |
| slot in cam 158 | 168 |
| fork tube | 170 |
| pin passing through fork tube 170 and torsion | 172 |
| spring 164 | |
| slot in hammer 150 | 174 |
| pin passing through slot 174 in hammer and on | 176 |
| which hammer rotates | |
| hole in bolt housing 130 | 178 |
| hole in cam 158 | 180 |
| pin passing through hole 178 in bolt housing | 182 |
| 130 and through hole 180 in cam 158 to keep | |
| bolt 120 from coming out of bolt housing 130 | |
| and allowing cam 158 to rotate | |
| holes in tines of fork 162 | 184 |
| pin received in holes 184 connecting fork 162 | 186 |
| to hammer 150 | |
| pin passing through bolt 120 at hole 142 and | 188 |
| cam slot 168 | |
| holes in inner surface of actuator housing 128 | 190 |
| push-in rubber inserts received in holes 190 to | 192 |
| provide silent operation of paddle actuator 126 | |
| linkage connecting the underside of paddle | 194 |
| actuator 126 to actuator housing 128 | |
| extension on paddle actuator 126 | 196 |

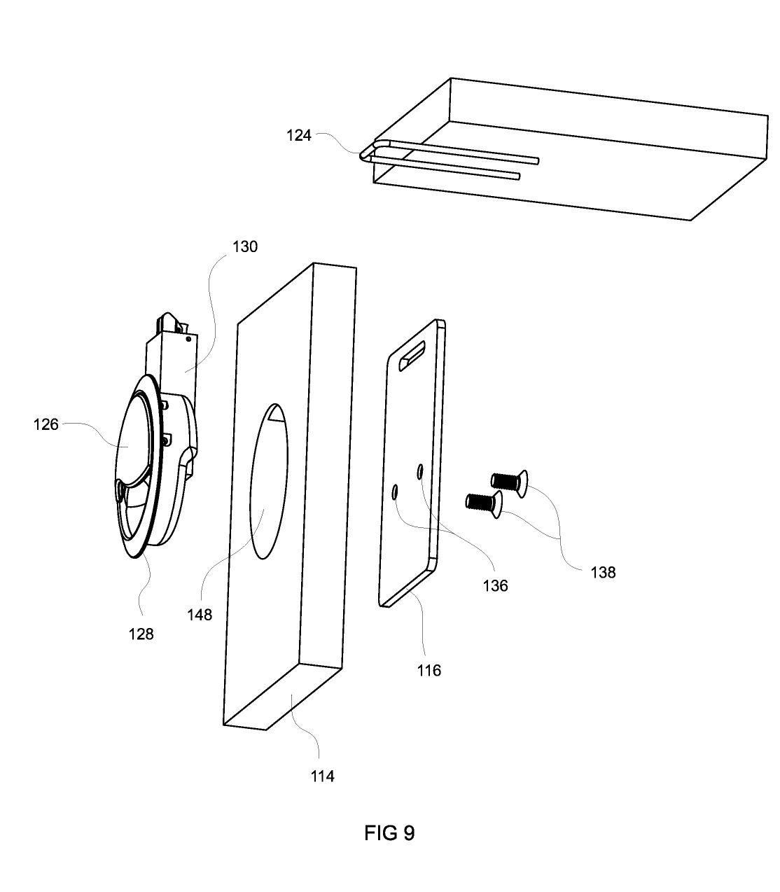

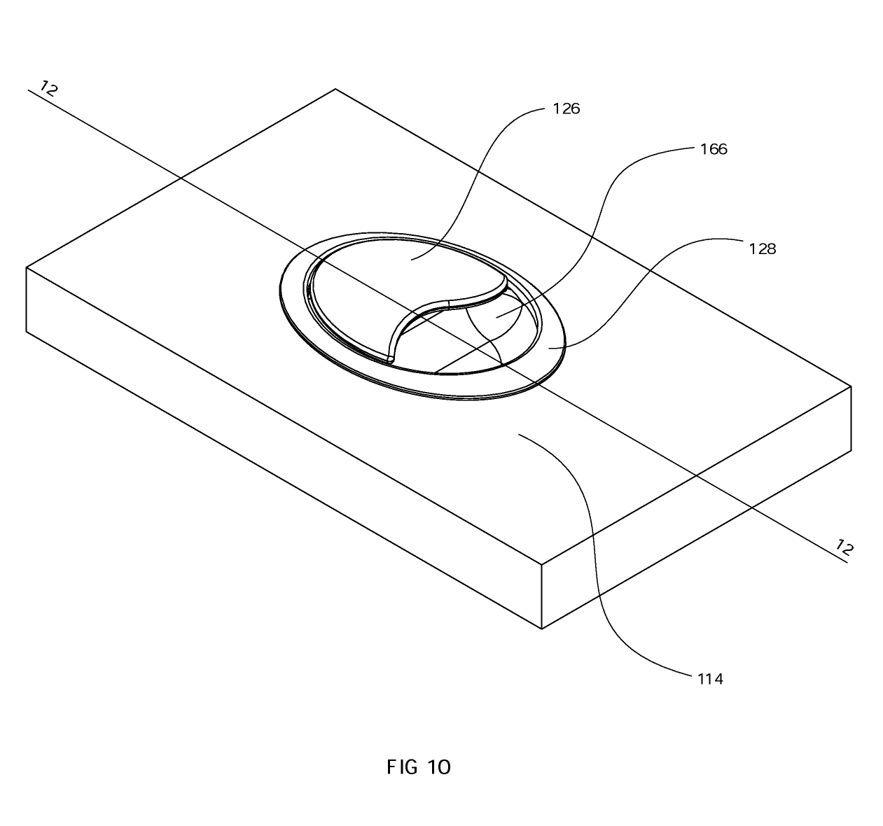

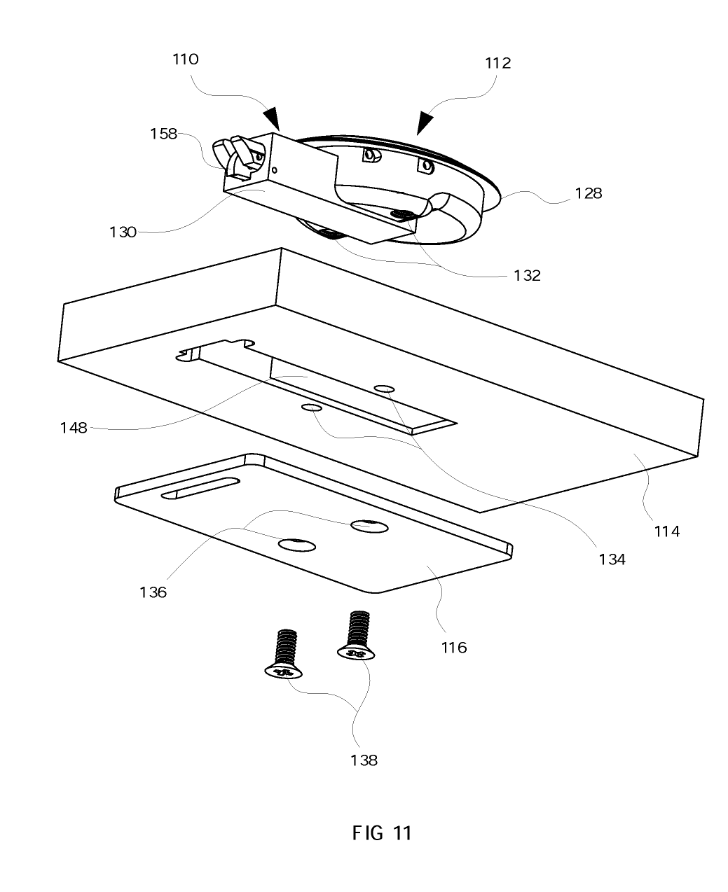

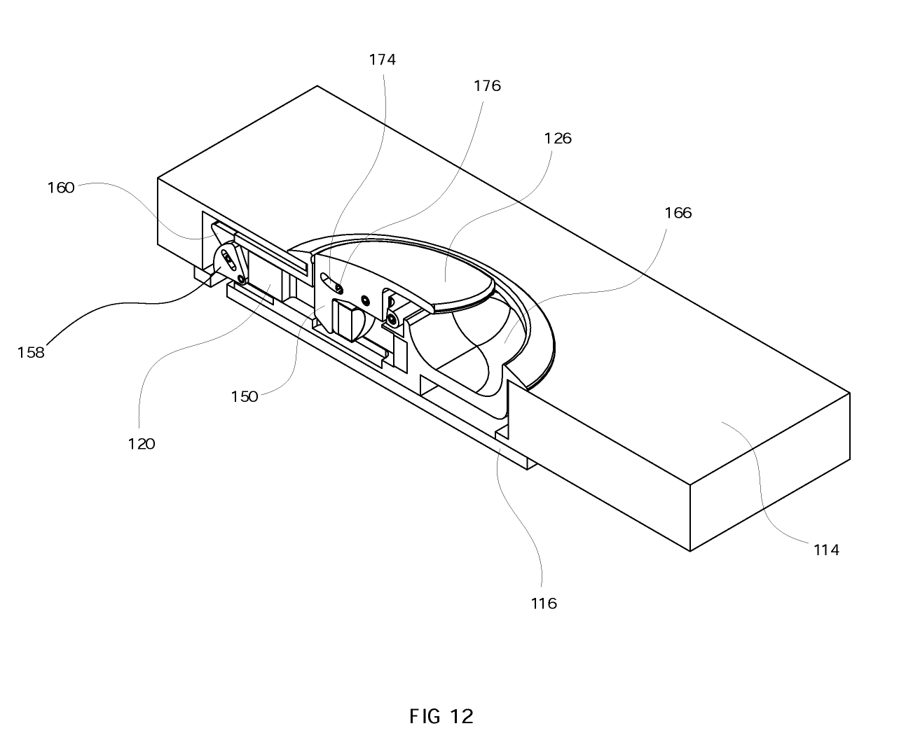

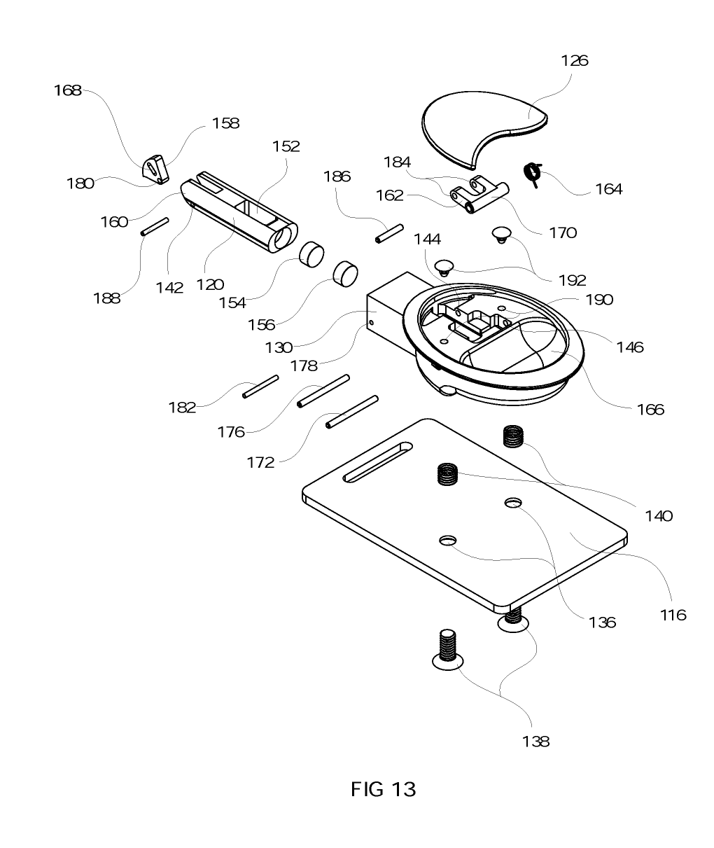

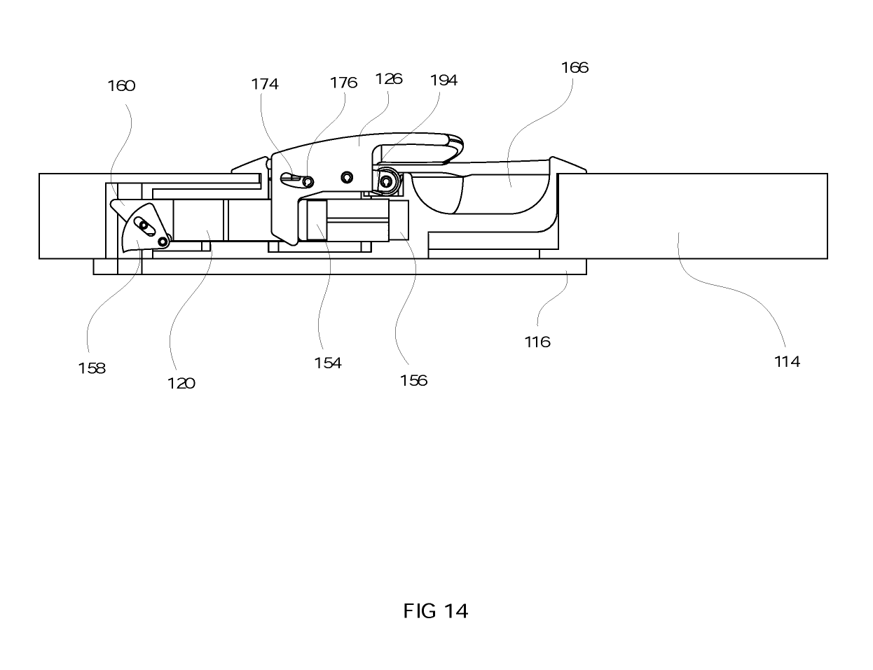

Turning to the embodiment of FIGS. 9 to 16, as is shown, the actuator housing assembly 112 with paddle actuator 126 and the bolt mechanism assembly 110 are made as a unit and then installed in opening 148 in a panel 114.

The unitary latching system of this embodiment comprising a bolt housing 130 and actuator housing 128 is intended to be mounted on panel 114 with backing plate 116. The screws 138 pass through holes 136 in backing plate 116 and holes 134 in panel 114 and are received in helicoils 140 in holes 132 in actuator housing 128.

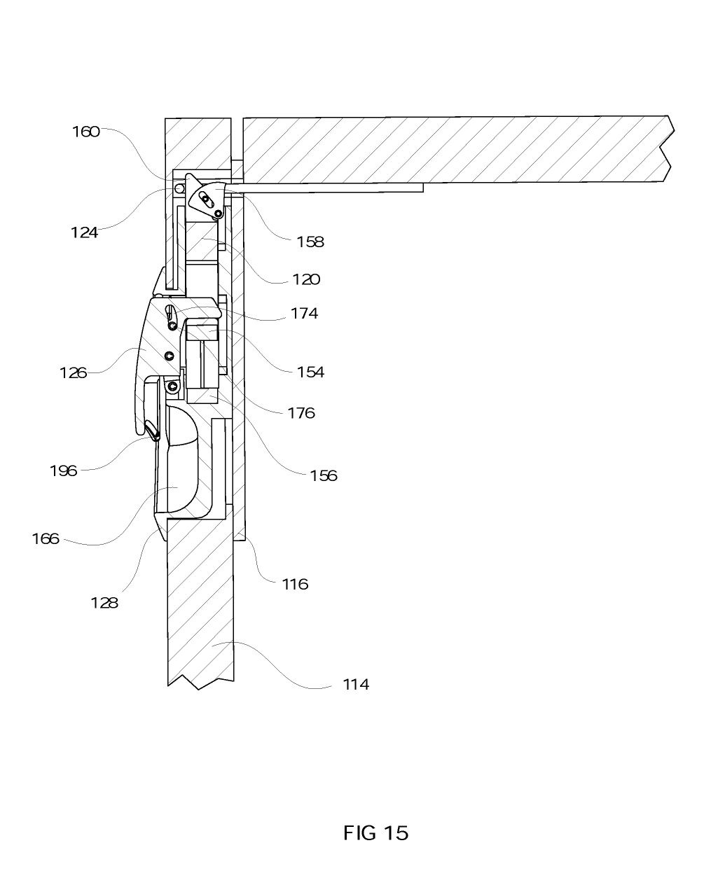

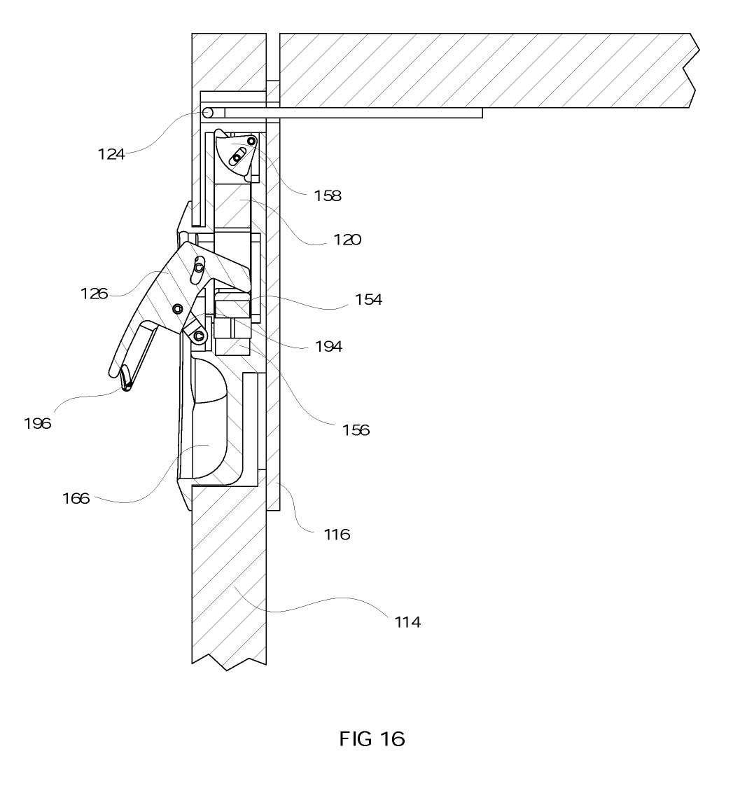

The paddle actuator carrying hammer 130 operates bolt 120. When the paddle actuator 126 is lifted up by inserting fingers in access opening 166, the hammer 150 reaches through opening 152 in bolt 120 to overcome the forces repelling magnets 154 and 156 of opposing polarity, as can be seen by comparing FIGS. 15 and 16, to withdraw the end 160 of bolt 120 and cam 158 from striker 124 to unlatch the panel 114. The paddle actuator 126 with hammer 150 rotates on pin 176 carried in holes 144. Pin 176 also passes through slot 174 in hammer 150.

The pin 182 received in holes 178 at each side at the end of bolt housing 130 goes through hole 180 in cam 158 and also prevents bolt 120 from coming out of the end of bolt housing 130. The cam 158 rotates on pin 182.

Pin 188 passes through hole 142 in bolt 120 and cam slot 168.

Pin 172 carried in holes 146 passes through fork tube 170 of fork 162 and through the center of torsion spring 164. The torsion spring serves to assure that bolt 120 is engaged in striker 124 when the paddle actuator 126 is released from upward or outward manual movement.

The pin 186 which passes through the holes 184 in tines of fork 162 connects the fork 162 to hammer 150.

The holes 190 in the inner surface of actuator housing 128 receive push-in rubber inserts 192. The inserts serve to provide silent engagement of the actuator 126 with actuator housing 128 when the actuator 126 is released to close and latch.

The linkage 194 connects the underside of paddle actuator 126 to actuator housing 128.

The extension 196 on paddle actuator 126 limits the travel of the paddle actuator so that the bolt 120 is fully extended and latched when the paddle actuator is released from manual upward or outward movement.

What is claimed is:

1. An easily modified closure latching system comprising the combination of a bolt mechanism assembly and an actuator housing assembly,
said bolt mechanism assembly comprising:
a backing plate adapted to be mounted on a complementary surface of a panel;
a bolt mechanism assembly housing attached to said backing plate;
a sliding bolt assembly carried by said bolt mechanism assembly housing, said sliding bolt assembly including a bolt adapted to engage and latch to a striker to close;
magnetic biasing means in said housing for biasing said end of the bolt out of the housing to latch to the striker;
said bolt mechanism housing assembly including passage access for an internal cam adapted to overcome said magnetic biasing means and withdraw said end of the bolt to unlatch said external cam from said striker; and
complementary means attachably and detachably joining said bolt mechanism assembly to said actuator housing assembly;
said actuator housing assembly comprising:
an actuator housing having an opening therein;
a movable actuator member received in said opening, said actuator member having a front surface and a rear surface and being movable in said opening;
said rear surface of said movable actuator member carrying a magnet adapted to rotate said internal cam when the actuator member is moved inwardly in said opening and to cause the internal cam to return to its original position in said opening when the actuator member is allowed to return to its original position, inward movement of said actuator member causing said bolt to withdraw sufficiently into said housing to unlatch said bolt from said striker.

2. The latching system of claim 1 wherein said magnetic biasing means comprises a pair of magnets of opposing polarity.

3. The latching system of claim 1 wherein said backing plate extends beyond said housing.

4. The latching system of claim 1 wherein said housing is integrally formed with said backing plate.

5. The latching system of claim 1 wherein said backing plate on said bolt mechanism assembly has screw holes therein and said actuator housing assembly has screw receiving openings and screws are received in said holes and are held by said openings.

6. The latching system of claim 1 wherein the bolt mechanism assembly and the actuator housing assembly are mounted on opposite sides of a panel.

7. The latching system of claim 1 wherein said actuator member is a paddle.

8. The latching system of claim 1 wherein said actuator member is an oval paddle.

9. The latching system of claim 1 wherein said actuator member is a push button.

10. The latching system of claim 1 wherein said actuator member is a rocker.

11. The latching system of claim 1 wherein said complementary means comprise a backing plate on said bolt mechanism assembly having screw holes therein and screw receiving openings on the actuator housing assembly and screws are received in said holes and are held by said openings.

12. An easily modified closure latching system for a movable panel having an edge adjacent a fixed striker comprising a bolt and actuator assembly, comprising:
a sliding bolt carried by a bolt housing, said bolt adapted to engage and latch to a striker to close;
magnetic biasing means in said housing for biasing said end of the bolt out of the housing to latch to the striker;
said bolt housing including passage access for a hammer adapted to overcome said magnetic biasing means and withdraw said end of the bolt to unlatch from said striker;
an actuator housing having an opening therein;
a movable actuator member received in said opening, said actuator member having a front surface and a rear surface and being movable in said opening;
said movable actuator member operating a hammer, said hammer being adapted to be moved inwardly in said opening by said actuator and means associated with said actuator to cause the hammer to return to its original position when the actuator member is allowed to return to its original position, inward movement of said actuator member causing said bolt to withdraw sufficiently into said bolt housing to unlatch said bolt from said striker.

13. The latching system of claim 12 wherein said magnetic biasing means comprises a pair of magnets of opposing polarity.

14. The latching system of claim 12 carried by a backing plate extends beyond said housing.

15. The latching system of claim 12 wherein said system is integrally formed with said backing plate.

16. The actuator housing assembly of claim 12 wherein said actuator member is a paddle.

17. The actuator housing assembly of claim 12 wherein said actuator member is an oval paddle.

18. The actuator housing assembly of claim 12 wherein said actuator member is a push button.

19. The actuator housing assembly of claim 12 wherein said actuator member is a rocker.
